(19) United States
(12) Patent Application Publication
(10) Pub. No.: US 2009/0065609 A1
(43) Pub. Date: Mar. 12, 2009

(54) INJECTOR

(75) Inventor: Kazunori SUZUKI, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/197,426

(22) Filed: Aug. 25, 2008

(30) Foreign Application Priority Data
Sep. 10, 2007 (JP) 2007-234543

(51) Int. Cl. B05B 12/00

(52) U.S. Cl. 239/265.27

(57) ABSTRACT

An injector includes a nozzle hole formation part having a nozzle_hole formation area and nozzle holes in at least one circle shape in the formation area. The formation area is divided into central and peripheral regions by a predetermined circle, the former inward from the predetermined circle and the latter in the periphery of the central region. The nozzle holes include outputting nozzle holes in the peripheral region and at least one cooling nozzle hole in the central region. Fuel through the outputting nozzle holes contributes to engine output. A smaller amount of fuel than a fuel amount through the outputting nozzle hole is injected through the cooling nozzle hole to cool the central region. A ratio of a second total fuel amount through the cooling nozzle hole to an overall total fuel amount ranges from 0.05 to 0.37.

### CROSS REFERENCE TO RELATED APPLICATION

This application is based on and incorporates herein by reference Japanese Patent Application No. 2007-234543 filed on Sep. 10, 2007.

### BACKGROUND OF THE INVENTION

1. Field of the Invention

The present invention relates generally to an injector, and more particularly to an injector that injects fuel into an internal combustion engine, for example.

2. Description of Related Art

An injector, which injects fuel directly into a cylinder of an internal combustion engine, for example, is known as a conventional injector (see, for example, JP2000-38974A and JP10-159688A). In this kind of injector, fuel injected through a nozzle hole needs to spread in a combustion chamber of the cylinder immediately under the nozzle hole.

In JP2000-38974A, at least four nozzle holes are arranged in a shape of a single annulus ring, and a spray of fuel injected through the nozzle holes is formed in a hollow conical shape as a whole. According to the above technology, an axis of the nozzle hole is inclined to be further away from a central axis of a nozzle hole plate extending in its thickness direction in a direction from a nozzle hole inlet side toward a nozzle hole outlet side. On the nozzle hole plate as a nozzle hole formation part, a nozzle hole is not arranged inward of these nozzle holes, that is, in a central region surrounded by the nozzle holes.

In JP10-159688A, an inner circumference and a surrounding area of a nozzle hole on a nozzle hole plate are coated with an FAS layer made of fluoro alkyl silane (FAS). The above FAS layer has liquid repellency due to the existence of a fluoro alkyl group.

In the injector according to the technology of JP2000-38974A, the nozzle hole formed in the nozzle hole plate is exposed to hot gas in the combustion chamber. Consequently, residual fuel which has remained around the nozzle hole after the fuel injection is altered into deposits (carbonaceous compound) to deposit around the nozzle hole, and thereby the nozzle hole may be blocked by the deposits. If not blocking the nozzle hole, the nozzle hole is a microscopic hole of about 100 μm because of fuel atomization. Thus, the growth of the deposits to such an extent that they enter into the nozzle hole may decrease or fluctuate fuel injection quantity as a fuel injection characteristic. For example, an adverse effect may be produced on a fuel-spray state.

According to the technology of JP10-159688A, the nozzle hole plate coated with the FAS layer has action (liquid repelling action) to lift the residual fuel off the coated surface and repel it due to the existence of the fluoro alkyl group. Accordingly, adhesion of the residual fuel is limited, so that formation the deposits can be alleviated.

However, in the technology of JP10-159688A, there are concerns about alteration or deterioration of the FAS layer after its prolonged exposure to a high temperature state. In the event of the alteration of the FAS layer and the like, the liquid repellency may deteriorate.

The inventor devoted himself to research into a mechanism of generating the deposits and as a result, found out the following.

The deposits are generated after the residual fuel produces chemical reactions other than combustion, or impure substances (e.g., carboxylate) in the residual fuel are deposited. Even though other deposits are attached to the above deposits as a core and thereby the deposits grow, bonding force between the deposits should be comparatively weak and the deposits should be easily exfoliated. Irrespective of whether the nozzle hole plate is coated in the FAS layer, the deposits grow into deposits that are firmly fixed on and difficult to exfoliate off a surface of the nozzle hole plate.

Heavy elements such as phosphorus (P) and zinc (Zn) contained in an engine cleaning agent or the like, exist around the nozzle hole on the nozzle hole plate surface in the combustion chamber of the cylinder. The heavy elements such as phosphorus (P) and zinc (Zn) react with silicon dioxide (SiO2) in silane of the altered and deteriorated FAS layer, and accordingly turn into low-melting glass. Each deposit adheres on the FAS-coated surface of the plate to such a degree that it is difficult to exfoliate, due to the above low-melting glass.

In the case of the nozzle hole plate without the FAS layer, on the other hand, the low-melting glass may be produced through the intervention of silicon (Si) in a silicon compound, which is used as an additive agent to engine oil for the defoaming purpose. As a result, each deposit may adhere on the surface to such a degree that it is difficult to exfoliate.

Moreover, the firmly fixed deposits tend to grow in a central region on the nozzle hole plate where the nozzle hole is not arranged. In other words, irrespective of whether the nozzle hole plate is coated in the FAS layer, the deposits adhered on the plate grow when temperature of the plate surface rises (e.g., 400° C. or higher).

The term low-melting glass here means amorphous glass, which is generated at about 400° C.

### SUMMARY OF THE INVENTION

The present invention addresses the above disadvantages. Thus, it is an objective of the present invention to limit an increase of heat temperature of a nozzle hole formation part of an injector that injects fuel directly into a cylinder of an internal combustion engine.

To achieve the objective of the present invention, there is provided an injector that is configured to inject fuel into a cylinder of an internal combustion engine. The injector includes a nozzle hole formation part. The nozzle hole formation part includes a nozzle hole formation area and a plurality of nozzle holes. The nozzle hole formation area is an end surface of the nozzle hole formation part on a downstream side of the nozzle hole formation part in a fuel flow direction. The plurality of nozzle holes is formed in a shape of at least one circle in the nozzle hole formation area, and fuel is injected through the plurality of nozzle holes. The nozzle hole formation area is divided into a central region and a peripheral region by a predetermined circle that is concentric with the at least one circle, the central region being located radially inward from the predetermined circle and the peripheral region being located on an outer circumferential side of the central region. The plurality of nozzle holes includes a plurality of outputting nozzle holes formed in the peripheral region such that fuel is injected into the cylinder through the plurality of outputting nozzle holes to contribute to an output of the engine, and at least one cooling nozzle hole in the central region such that a smaller amount of fuel than an amount of fuel flowing through the outputting nozzle hole is injected through the at least one cooling nozzle hole so as to cool the central region. The plurality of outputting nozzle holes and the at least one cooling nozzle hole are configured such that a ratio of a second total amount of fuel flowing through the at least one cooling nozzle hole to an overall total fuel amount that is a sum of the second total amount and a first total amount of fuel flowing through the plurality of outputting nozzle holes is in a range of 0.05 to 0.37.

To achieve the objective of the present invention, there is also provided an injector that is configured to inject fuel into a cylinder of an internal combustion engine. The injector includes a nozzle hole formation part. The nozzle hole formation part includes a nozzle hole formation area and a plurality of nozzle holes. The nozzle hole formation area is an end surface of the nozzle hole formation part on a downstream side of the nozzle hole formation part in a fuel flow direction. The plurality of nozzle holes is formed in a shape of at least one circle in the nozzle hole formation area, and fuel is injected through the plurality of nozzle holes. The nozzle hole formation area is divided into a central region and a peripheral region by a predetermined circle that is concentric with the at least one circle, the peripheral region being located radially outward from the predetermined circle and the central region being located on an inner circumferential side of the peripheral region. The plurality of nozzle holes includes a plurality of outputting nozzle holes formed in the central region such that fuel is injected into the cylinder through the plurality of outputting nozzle holes to contribute to an output of the engine, and at least one cooling nozzle hole in the peripheral region such that a smaller amount of fuel than an amount of fuel flowing through the outputting nozzle hole is injected through the at least one cooling nozzle hole so as to cool the peripheral region. The plurality of outputting nozzle holes and the at least one cooling nozzle hole are configured such that a ratio of a second total amount of fuel flowing through the at least one cooling nozzle hole to an overall total fuel amount that is a sum of the second total amount and a first total amount of fuel flowing through the plurality of outputting nozzle holes is in a range of 0.05 to 0.37.

Furthermore, to achieve the objective of the present invention, there is provided an injector that is configured to inject fuel into a cylinder of an internal combustion engine. The injector includes a nozzle hole formation part. The nozzle hole formation part includes a nozzle hole formation area and a plurality of nozzle holes. The nozzle hole formation area is an end surface of the nozzle hole formation part on a downstream side of the nozzle hole formation part in a fuel flow direction. The plurality of nozzle holes is formed in a shape of at least one circle in the nozzle hole formation area, and fuel is injected through the plurality of nozzle holes. The nozzle hole formation area is divided into a central region and a peripheral region by a predetermined circle that is concentric with the at least one circle, the central region being located radially inward from the predetermined circle and the peripheral region being located on an outer circumferential side of the central region. The plurality of nozzle holes includes a plurality of outputting nozzle holes formed in the peripheral region and at least one cooling nozzle hole formed in the central region. The plurality of outputting nozzle holes and the at least one cooling nozzle hole are formed such that a spray travel of fuel injected through each of the at least one cooling nozzle hole is shorter than a spray travel of fuel injected through each of the plurality of outputting nozzle holes when the injector injects fuel. The plurality of outputting nozzle holes and the at least one cooling nozzle hole are formed to satisfy an expression of 1/10×A1≦A2≦½×A1 given that A1 is an opening area of each of the plurality of outputting nozzle holes and A2 is an opening area of each of the at least one cooling nozzle hole. The plurality of outputting nozzle holes is formed such that a first hole axis of each of the plurality of outputting nozzle holes separates from a central axis of the nozzle hole formation part extending in a thickness direction of the nozzle hole formation part in a direction from an fuel inlet side toward an fuel outlet side of the nozzle hole formation part. The at least one cooling nozzle hole is formed such that a second hole axis of each of the at least one cooling nozzle hole approaches the central axis of the nozzle hole formation part in the direction from the fuel inlet side toward the fuel outlet side of the nozzle hole formation part.

### BRIEF DESCRIPTION OF THE DRAWINGS

The invention, together with additional objectives, features and advantages thereof, will be best understood from the following description, the appended claims and the accompanying drawings in which:

FIG. 1 is a sectional diagram illustrating a peripheral part of a nozzle hole formation part of an injector according to a first embodiment of the invention;

FIG. 2 is a plan view illustrating a nozzle hole plate as the nozzle hole formation part according to the first embodiment viewed from a downstream side in a fuel flow direction;

FIG. 3A1 is a segmentary diagram illustrating an outputting nozzle hole in the nozzle hole formation part in FIG. 2;

FIG. 3A2 is a segmentary diagram illustrating the outputting nozzle hole;

FIG. 3A3 is a segmentary diagram illustrating the outputting nozzle hole;

FIG. 3B1 is a segmentary diagram illustrating a cooling nozzle hole in the nozzle hole formation part in FIG. 2;

FIG. 3B2 is a segmentary diagram illustrating the cooling nozzle hole;

FIG. 3B3 is a segmentary diagram illustrating the cooling nozzle hole;

FIG. 4 is a sectional diagram illustrating the nozzle hole plate in FIG. 2;

FIG. 5 is a sectional diagram illustrating an example of the injector according to the first embodiment;

FIG. 6 is a sectional diagram illustrating an attachment position of the injector according to the first embodiment, and a spray of the valve into a combustion chamber;

FIG. 7 is a graph illustrating a relationship between a ratio of a gross opening area of the cooling nozzle holes to an overall gross opening area, and heat temperature in a central region of a downstream-side end surface of the nozzle hole plate according to the first embodiment;

FIG. 8 is a plan view illustrating a nozzle hole plate according to a second embodiment of the invention;

FIG. 9 is a sectional diagram illustrating the nozzle hole plate in FIG. 8;

FIG. 10A1 is a segmentary diagram illustrating an outputting nozzle hole in a nozzle hole formation part in FIG. 8;

FIG. 10A2 is a segmentary diagram illustrating the outputting nozzle hole;

FIG. 10A3 is a segmentary diagram illustrating the outputting nozzle hole;

FIG. 10B1 is a segmentary diagram illustrating a cooling nozzle hole in the nozzle hole formation part in FIG. 8;

FIG. 10B2 is a segmentary diagram illustrating the cooling nozzle hole;

FIG. 10B3 is a segmentary diagram illustrating the cooling nozzle hole;

FIG. 11 is a plan view illustrating a nozzle hole plate according to a third embodiment of the invention;

FIG. 12 is a sectional diagram illustrating the nozzle hole plate in FIG. 11;

FIG. 13A1 is a segmentary diagram illustrating an outputting nozzle hole in a nozzle hole formation part in FIG. 11;

FIG. 13A2 is a segmentary diagram illustrating the outputting nozzle hole;

FIG. 13A3 is a segmentary diagram illustrating the outputting nozzle hole;

FIG. 13B1 is a segmentary diagram illustrating a cooling nozzle hole in the nozzle hole formation part in FIG. 11;

FIG. 13B2 is a segmentary diagram illustrating the cooling nozzle hole;

FIG. 13B3 is a segmentary diagram illustrating the cooling nozzle hole;

FIG. 14 is a plan view illustrating a nozzle hole plate according to a fourth embodiment of the invention;

FIG. 15 is a sectional diagram illustrating the nozzle hole plate in FIG. 14;

FIG. 16A1 is a segmentary diagram illustrating an outputting nozzle hole in a nozzle hole formation part in FIG. 14;

FIG. 16A2 is a segmentary diagram illustrating the outputting nozzle hole;

FIG. 16A3 is a segmentary diagram illustrating the outputting nozzle hole;

FIG. 16B1 is a segmentary diagram illustrating a cooling nozzle hole in the nozzle hole formation part in FIG. 14;

FIG. 16B2 is a segmentary diagram illustrating the cooling nozzle hole; and

FIG. 16B3 is a segmentary diagram illustrating the cooling nozzle hole.

### DETAILED DESCRIPTION OF THE INVENTION

Embodiments, in which an injector of the invention is embodied, are described below as examples with reference to drawings.

### First Embodiment

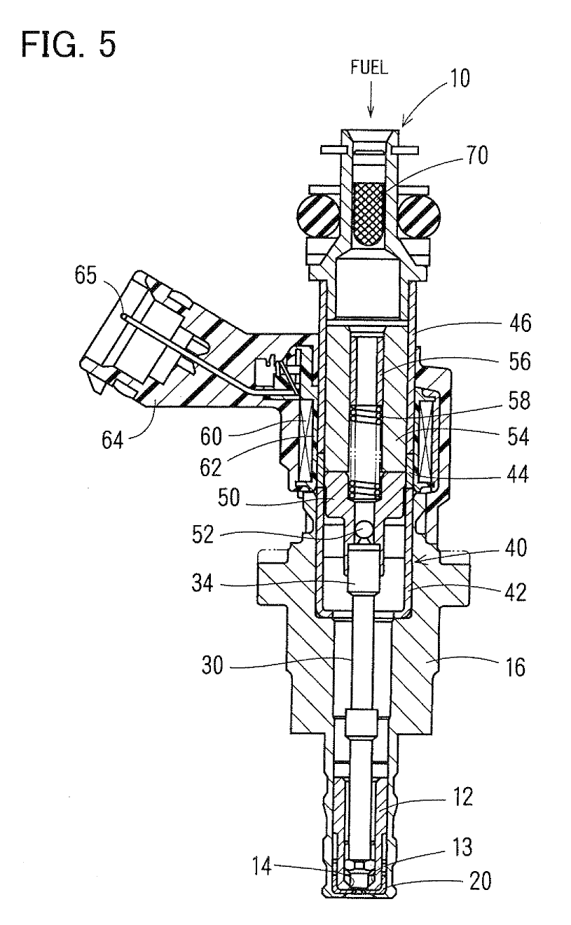

An injector 10 of a first embodiment of the invention is shown in FIG. 5. The injector 10 is attached to a cylinder head 102. The injector 10 is an injector for a direct injection gasoline engine, which injects fuel directly into a combustion chamber 106 defined by an inner circumferential surface of a cylinder block 100, an inner circumferential surface of the cylinder head 102, and an upper end surface of a piston 104. An injection pressure of the injector 10 is in a range of 1 MPa to 30 MPa.

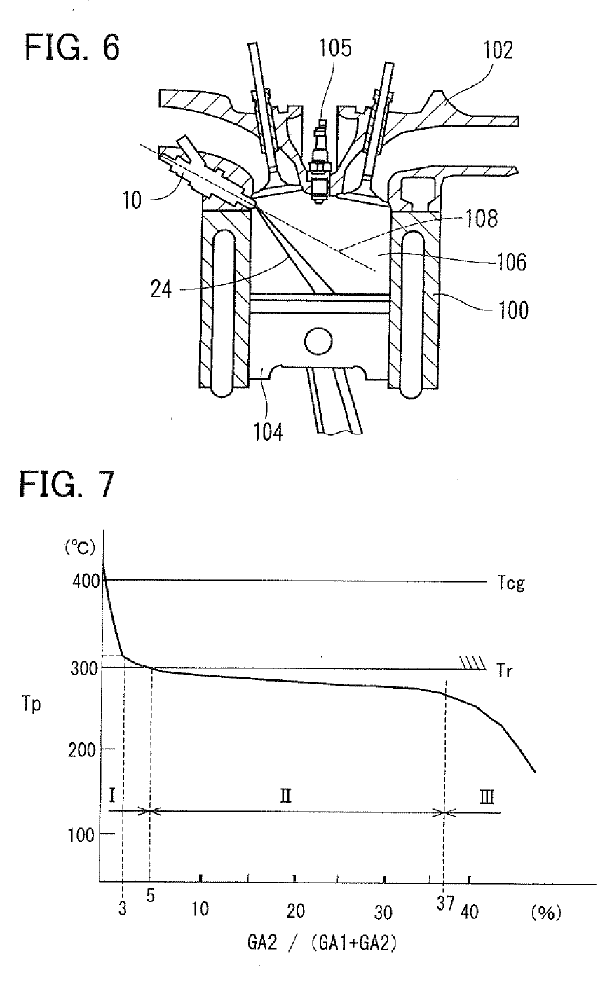

It is desirable that a spray of fuel injected from the injector 10 should be atomized to spread into the combustion chamber 106 in FIG. 6. The above spray of fuel has basically a shape of a spray 24, which has a hollow conical shape, for example.

The spray 24 may be formed by suitably setting a shape or arrangement of a nozzle hole formed on a leading-end side of the injector 10. Shapes and arrangements of an outputting nozzle hole and a cooling nozzle hole that relate to the present invention, and fuel sprays injected through the above nozzle holes are described in greater detail hereinafter.

Such a spray 24 is inclined with respect to the axis 108 such that it separates toward an end face of the piston 104 from an axis 108 of the injector 10 along a direction, in which a valve member (nozzle needle) 30 of the injector 10 in FIG. 5 engages a valve seat 14, as it goes in the injection direction. By suitably setting an optimal angle, at which the spray 24 is inclined with respect to the axis 108 of the injector 10 so that the spray 24 spreads into the combustion chamber 106, adhesion of the spray 24 on an ignition plug 105, or on the piston 104 and the inner wall surface of the cylinder block 100 that define the combustion chamber 106 in a liquid state is limited.

As shown in FIG. 5, a valve body 12 is fixed by welding to an inner wall of a fuel-injection side-end portion of a valve housing 16. The valve body 12 includes a conic surface 13 as its inner circumferential surface whose diameter decreases in a direction a nozzle hole plate 20 in a fuel flow direction. The conic surface 13 has the valve seat 14, which the nozzle needle 30 as the valve member engages.

The nozzle hole plate 20 is formed in a cylindrical shape having a bottom portion, and is held between an inner wall of a bottom portion of the valve housing 16 and an outer wall of a bottom portion of the valve body 12. The nozzle hole plate 20 having nozzle holes 21, 22 that relate to the outputting nozzle hole and the cooling nozzle hole is described in greater detail hereinafter.

As shown in FIG. 5, a cylindrical member 40 is inserted against an inner peripheral wall of an opposite side of the nozzle hole of the valve housing 16, and is fixed by welding to the valve housing 16. The cylindrical member 40 includes a first magnetic cylinder portion 42, a nonmagnetic cylinder portion 44, and a second magnetic cylinder portion 46 from the nozzle hole plate 20 side. The nonmagnetic cylinder portion 44 prevents a magnetic short circuit of the first magnetic cylinder portion 42 and the second magnetic cylinder portion 46.

A movable core 50 is formed in a cylindrical shape from a magnetic material, and is fixed by welding to an end portion 34 of the nozzle needle 30 on an opposite side of the nozzle hole. The movable core 50 reciprocates together with the nozzle needle 30. A discharge hole 52 passing through a cylindrical wall of the movable core 50 serves as a fuel passage through which the inside and outside of the movable core 50 communicate.

A fixed core 54 is formed in a cylindrical shape from a magnetic material. The fixed core 54 is inserted into the cylindrical member 40, and is fixed by welding to the cylindrical member 40. The fixed core 54 and the nozzle hole are located on opposite sides of the movable core 50, and the fixed core 54 faces the movable core 50.

An adjusting pipe 56 is press-fitted into the fixed core 54, and defines inside a fuel passage. A spring 58 engages the adjusting pipe 56 at its one end part, and engages the movable core 50 at its other end part. A load of the spring 58 applied to the movable core 50 is varied according to a degree of press fitting of the adjusting pipe 56. The movable core 50 and the nozzle needle 30 are urged toward the valve seat 14 by urging force of the spring 58.

A coil 60 is wound around a spool 62. A terminal 65 is insert molded in a connector 64, and is electrically connected to the coil 60. On energization of the coil 60, Magnetic attraction force is generated between the movable core 50 and the fixed core 54. The movable core 50 is attracted to a side of the fixed core 54 against the urging force of the spring 58.

A filter 70 is disposed on an upstream side of the fixed core 54 in the fuel flow direction for removing foreign substances in fuel that is supplied to an injector 10. Fuel, which has flowed into the fixed core 54 through the filter 70, passes through the fuel passage in the adjusting pipe 56, a fuel passage in the movable core 50, the discharge hole 52, and a gap between an inner circumferential wall of the valve housing 16 and an outer circumferential wall of the nozzle needle 30 in this order. When the nozzle needle 30 disengages from the valve seat 14, fuel passes through an opening passage formed between the nozzle needle 30 and the valve seat 14, and is led into the nozzle holes 21, 22.

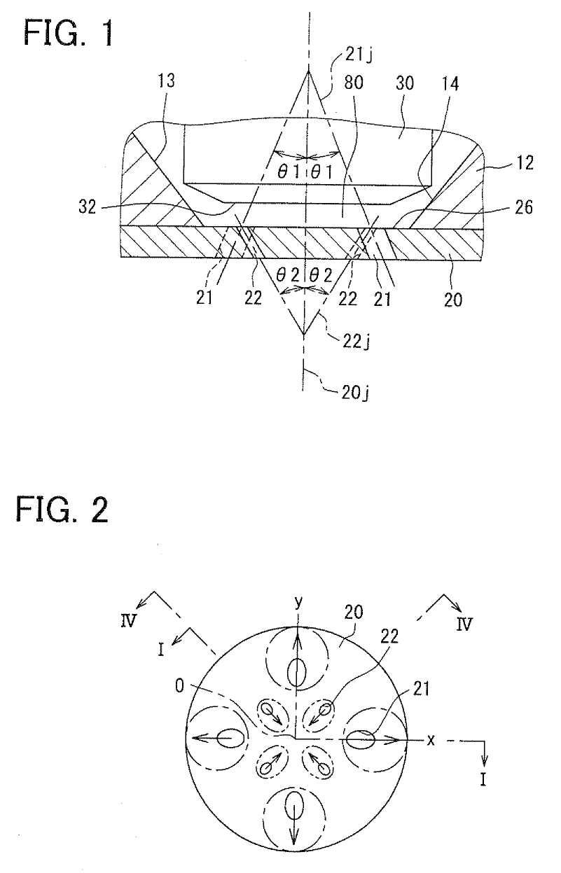

Next, shapes and arrangements of the nozzle hole plate 20, and the nozzle hole (outputting nozzle hole) 21 and the nozzle hole (cooling nozzle hole) 22 that are formed in the nozzle hole plate 20 are explained below in detail with reference to FIG. 1 to FIG. 4. In the following description, although a side of the injector 10 into which fuel is injected is referred to as a ‘lower’ side, and an opposite side of the above is referred to as a ‘upper’ side for the purpose of illustrating embodiments, these sides do not relate to an actual installation direction of the injector 10 in the engine.

The invention is characterized in the nozzle hole plate 20 and the above nozzle holes 21, 22 shown in FIG. 2 and FIG. 4, and particularly in shapes and arrangements of the outputting nozzle hole 21 and the cooling nozzle hole 22 formed on a lower surface, that is, a downstream side end face (end face facing the combustion chamber) of the nozzle hole plate 20.

Fuel, which is injected such that a fuel spray through the outputting nozzle hole 21 spreads in the combustion chamber 106 of a cylinder so as to contribute to engine output, is injected through the outputting nozzle hole 21.

A smaller amount of fuel than an amount of fuel flowing through the outputting nozzle hole 21, which is a part of fuel for flowing through the fuel passage in the outputting nozzle hole 21, is injected through the cooling nozzle hole 22. Furthermore, unlike the fuel spray of the outputting nozzle hole 21, the cooling nozzle hole 22 does not need to contribute to the engine output. Accordingly, the fuel spray of the cooling nozzle hole 22 does not need a penetration (fuel spray travel) that spreads in the combustion chamber 106 like the fuel spray of the outputting nozzle hole 21. Therefore, the fuel spray of the cooling nozzle hole 22 may have a very short penetration, which is locally atomized near the cooling nozzle hole 22 (see FIG. 4).

As shown in FIG. 2 viewed from a lower surface of the nozzle hole plate, the nozzle hole plate 20 has the outputting nozzle holes 21 (four outputting nozzle holes in the first embodiment) and the cooling nozzle holes 22 (four cooling nozzle holes in the first embodiment). The above nozzle holes 21, 22 are formed in the nozzle hole plate 20 such that an upper surface (surface facing the inside of the valve body 12 or on an upstream side in the fuel flow direction) and a lower surface (surface facing the combustion chamber 106 located outside) communicate through the nozzle holes 21, 22.

The number of the outputting nozzle holes 21 is not limited to four, and may be any number so long as there are two or more outputting nozzle holes 21. As well, the number of the cooling nozzle holes 22 is not limited to four, and may be any number so long as there is at least one cooling nozzle hole 22.

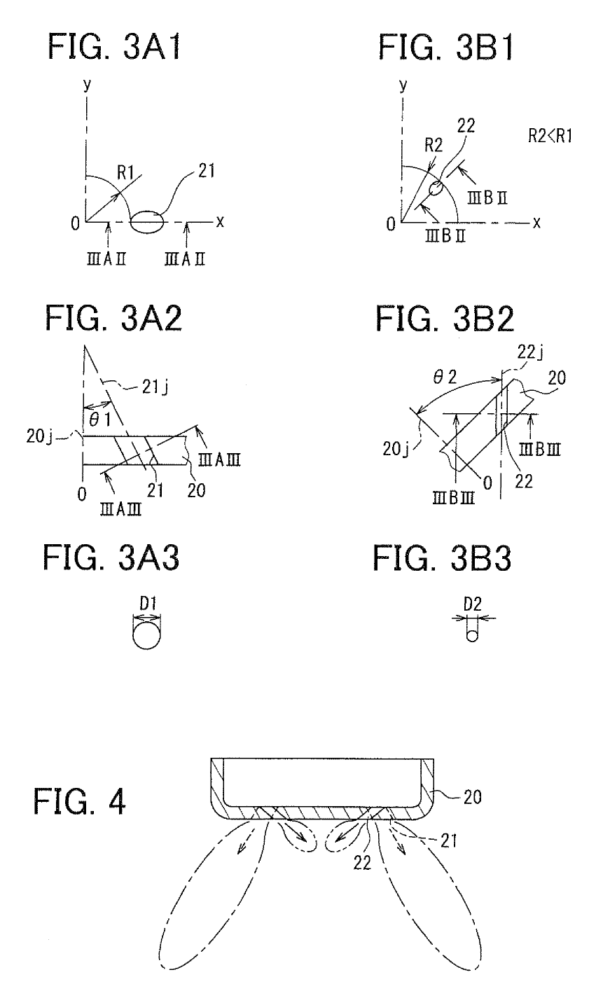

The four outputting nozzle holes 21 are formed in the same circumference with a central axis 20j, which extends along a board thickness direction of the nozzle hole plate 20, being its center. In other words, the outputting nozzle holes 21 are arranged in a shape of a single annulus ring. The outputting nozzle hole 21 has a round cross section (see FIG. 3A3) and is a straight hole (see FIG. 3A2).

As well, the four cooling nozzle holes 22 are formed in the same circumference with a central axis 20j, which extends along a board thickness direction of the nozzle hole plate 20, being its center. In other words, the cooling nozzle holes 22 are arranged in a shape of a single annulus ring. The cooling nozzle hole 22 has a round cross section (see FIG. 3B3) and is a straight hole (see FIG. 3B2).

The cooling nozzle hole 22 is arranged between adjacent outputting nozzle holes 21. The nozzle holes 21, 22 are arranged such that a second hole axis 22j of the cooling nozzle hole 22 and a first hole axis 21j of the outputting nozzle hole 21 do not cross.

As shown in FIG. 1, the first hole axis 21j of the outputting nozzle hole 21 is inclined to be further away from the central axis 20j of the nozzle hole plate 20 in a direction from an inlet toward an outlet of the outputting nozzle hole 21. A first angle (first inclined angle) θ1 between the first hole axis 21j and the central axis 20j is set in a range of 5 to 60°. The first inclined angle θ1 may be set in a range of 25 to 60°.

When the first inclined angle θ1 is smaller than 25°, fuel flowing in from an inlet side of the outputting nozzle hole 21 of the nozzle hole plate 20 does not include high turbulence energy due to a small first inclined angle θ1. Therefore, fuel atomization using the high turbulence energy cannot be achieved. On the other hand, although the turbulence energy is raised by making large the first inclined angle θ1, the outputting nozzle hole 21 is difficult to form with the first hole axis 21j inclined with respect to the central axis 20j of the nozzle hole plate 20 when the first inclined angle θ1 is larger than 60°.

As shown in FIG. 1, the second hole axis 22j of the cooling nozzle hole 22 is inclined to be closer to the central axis 20j of the nozzle hole plate 20 in a direction from an inlet toward an outlet of the cooling nozzle hole 22. A second angle (second inclined angle) θ2 between the second hole axis 22j and the central axis 20j is set in a range of 30 to 80°. The second inclined angle θ2 may be set in a range of 30 to 80°.

As shown in FIG. 1, the nozzle holes 21, 22 formed on the lower surface of the nozzle hole plate 20 are arranged such that an area (nozzle hole formation area) of the nozzle hole plate 20, in which a fuel passage for fuel flowing through the nozzle holes 21, 22 is formed, is divided by the nozzle holes 21, 22 between a central region (region up to a radius R1 in FIG. 3A1) inward of an area of the nozzle hole plate 20 for the outputting nozzle holes 21, which is formed in the shape of the single annulus ring, and a peripheral region located on an outer circumferential side of the central region.

As shown in FIG. 1 and FIG. 3A1, the outputting nozzle hole 21 is formed in such a peripheral region. On the other hand, as shown in FIG. 1 and FIG. 3B1, the cooling nozzle hole 22 is formed in the central region.

An opening area (i.e. diameter D2 in FIG. 3B3) of the cooling nozzle hole 22 may be smaller (D2<D1) than an opening area (i.e. diameter D1 in FIG. 3A3) of the outputting nozzle hole 21.

Generally, atomization of fuel is further improved as a size, that is, an opening area of a nozzle hole becomes smaller. A fuel spray travel (penetration) of a fuel spray atomized in the above manner becomes short. Therefore, it is easy to keep a fuel spray that is formed on a side of the cooling nozzle hole 22 near the central region, since the penetration of the cooling nozzle hole 22 is shorter than the penetration of the outputting nozzle hole 21.

Moreover, each opening area of the cooling nozzle hole 22 and the outputting nozzle hole 21 may satisfy the following relation. That is, given that the opening area of the outputting nozzle hole 21 is A1 and the opening area of the cooling nozzle hole 22 is A2, the each opening area may be set in a range of 1/10×A1≦A2≦½×A1.

In the above manner, the opening area A2 of the cooling nozzle hole 22 is set in a range of a tenth to half of the opening area A1 of the outputting nozzle hole 21. Accordingly, loss energy of the fuel passage, that is, pressure loss of a fuel flow in the cooling nozzle hole 22 is extremely increased as compared to pressure loss in the outputting nozzle hole 21, and jet energy of the fuel flow in the cooling nozzle hole 22 is effectively weakened.

When the opening area A2 is larger than a half of the opening areas A1 of the outputting nozzle hole 21, in the setting range of a ratio of the opening area A2 of the cooling nozzle hole 22, the jet energy of fuel injected through the cooling nozzle hole 22 cannot be limited to a small value. Accordingly, the spray through the cooling nozzle hole 22 may not be kept near a lower surface of the nozzle hole plate 20. When the opening area A2 is smaller than a tenth of the opening area A1 of the outputting nozzle hole 21, the jet energy is made small enough, but the cooling nozzle hole 22 is difficult to form.

As shown in FIG. 1, the nozzle hole plate 20, and the nozzle hole formation area, in particular, are formed in a generally plate-like shape, and furthermore, a fuel space 80 defined by a nozzle hole plate side end face 32 and a nozzle needle side end face 26 of the nozzle hole plate 20 is flattened. This is because the nozzle hole plate side end face 32 of the nozzle needle 30 is flat.

Such a nozzle hole formation area of the nozzle hole plate 20 is opposed to the flat space for fuel formed on the upper surface (end face on an upstream side in the fuel flow direction) of the nozzle hole plate 20, with the plate-shaped nozzle hole plate 20 therebetween. Moreover, the nozzle hole plate 20 is plate-shaped. Thus, heat capacity in the nozzle hole formation area is comparatively small.

The nozzle hole plate 20 is constantly cooled from its upper surface side by fuel stored in the fuel passage in the valve body 12 using the comparatively small heat capacity in the nozzle hole plate, and the central region on the lower surface (end face on a downstream side in the fuel flow direction), that is, on a side of the combustion chamber, is cooled by fuel injected through the cooling nozzle hole 22. Consequently, heat temperature of the nozzle hole plate 20 before the combustion is effectively lowered.

A smaller amount of fuel than the amount of fuel flowing through the outputting nozzle hole 21 is injected in the cooling nozzle hole 22. This means that a ratio (Qr/(Qt+Qr)) of the second total amount Qr of fuel to an overall total fuel amount (Qt+Qr) may be set in a range of 5%<Qr/(Qt+Qr)×100<37%, provided that a first total amount of fuel flowing through the outputting nozzle hole 21 is Qt, and a second total amount of fuel flowing through the cooling nozzle hole 22 is Qr. In other words, the ratio of the injection amount Qr of fuel injected through the cooling nozzle hole 22 is set in a range of 5 to 37% of the total injection amount (Qt+Qr) of fuel injected from the injector 10. Accordingly, a spray of fuel injected from the outputting nozzle hole 21 is stably formed in the combustion chamber 106, and the nozzle hole formation area is cooled down by fuel injected from the cooling nozzle hole 22.

When the ratio exceeds 37%, the jet energy of fuel injected from the outputting nozzle hole 21 is smaller than the jet energy of fuel injected from the cooling nozzle hole 22. As a result, a shape of spray on a side of the outputting nozzle hole 21, which should spread in the combustion chamber 106 may be disordered. This is because the disorder of the shape of spray on the side of the outputting nozzle hole 21 in the above manner has an adverse effect on the combustion.

When the above ratio is smaller than 5%, a cooling effect of cooling the nozzle hole plate 20 is reduced, and accordingly, generation of deposits may not be limited.

In the relation between each opening area of the cooling nozzle hole 22 and the outputting nozzle hole 21, the opening area A2 of the cooling nozzle hole 22 is set in a range of a tenth to half of the opening area A1 of the outputting nozzle hole 21. When a gross opening area GA2 of the cooling nozzle holes 22 is small enough compared to a gross opening area GA1 of the outputting nozzle holes 21, for example, fuel easily flows into the outputting nozzle hole 21 whose gross opening area is larger, and as a result, the amount of fuel injected through the cooling nozzle hole 22 is set at a small amount.

Thus, by suitably setting the gross opening area of the cooling nozzle holes 22, the amount of fuel injected through the cooling nozzle hole 22 is set at a small amount, and even by this small amount of fuel, the central region on the lower surface (end face on a combustion chamber side) of the nozzle hole plate, which is not found in conventional technologies, may be cooled down. When a ratio (GA2/(GA1+GA2)) of the gross opening area GA2 of the cooling nozzle holes 22 to an overall gross opening area (GA1+GA2) is in a range of 0 to 5%, the cooling effect is small as shown in a section I in FIG. 7. Accordingly, the above range is not sufficient to stably limit the generation of low melting glass, which leads to fixation of the deposits.

FIG. 7 illustrates the ratio (GA1/(GA1+GA2)) and a temperature Tp of the central part (central region)of the lower surface side of the nozzle hole plate 20. The ratio of 0%, that is, a conventional configuration without having a cooling nozzle hole indicates that the heat temperature of the central region of the nozzle hole plate 20 is equal to or larger than 400° C. exceeding a melting point Tcg of low melting glass. When the ratio of the gross opening area GA2 of the cooling nozzle holes 22, which are characteristics of the first embodiment, is increased to 3% in the section I corresponding to the ratio of a range of 0 to 5%, the temperature Tp goes down to nearly 300° C. and the heat temperature of the central region greatly decreases.

In a section II in FIG. 7, which corresponds to the ratio of a range of 5 to 37%, the above cooling effect is stably great, so that the generation of deposits can be effectively limited. In the section II, the heat temperature of the central region is reduced to equal to or smaller than 300° C. (Tr).

A section III in FIG. 7 corresponds to the ratio of a range of 37 to 100%. When the ratio exceeds 37%, an injection state (spray state) by the outputting nozzle hole 21 for obtaining the output is disordered. Thus, the combustion of fuel becomes worse and both fuel mileage and emission deteriorate.

Additionally, the relationship between the ratio (GA1/(GA1+GA2)) and the central region temperature Tp of the nozzle hole plate 20 has been described in FIG. 7. Alternatively, the ratio (GA1/(GA1+GA2)) of the gross opening area GA2 of the cooling nozzle holes 22 may be replaced with the ratio (Qr/(Qt+Qr)) of the total fuel amount Qr of the cooling nozzle holes 22.

In the first embodiment, at least two cooling nozzle holes 22 are formed in the central region.

According to the above configuration, it is not an indispensable condition that the cooling nozzle hole 22 contribute to the engine output like the outputting nozzle hole 21. Therefore, the spray of fuel injected through the cooling nozzle hole 22 may take any shape without any problem. Accordingly, two cooling nozzle holes 22, which is a comparatively small number, are arranged in the central region, for example. Thus, even when an area of the end face of the nozzle hole plate 20 in the central region is comparatively small, the cooling nozzle hole 22 may be arranged in the central region and thereby the central region is cooled.

In the first embodiment, the first hole axis 21j of the outputting nozzle hole 21 is inclined to be further away from the central axis 20j of the nozzle hole plate 20 in the direction from the inlet toward the outlet of the outputting nozzle hole 21. Furthermore, as shown in FIG. 1, the second hole axis 22j of the cooling nozzle hole 22 is inclined to be closer to the central axis 20j in the direction from the inlet toward the outlet of the cooling nozzle hole 22.

Accordingly, the fuel spray through the outputting nozzle hole 21 can be formed in a shape of spray such as a hollow conical shape, which easily spreads in the combustion chamber 106. Moreover, there is no possibility that the fuel spray on the side of the outputting nozzle hole 22 is disturbed by the fuel spray on the side of the cooling nozzle hole 22.

In addition, in the lower surface of the nozzle hole plate 20 shown in FIG. 4, a size of the spray injected from the cooling nozzle hole 22 is indicated by an alternate long and two short dashes line, and a size of the spray injected from the outputting nozzle hole 21 is indicated by an alternate long and short dash line.

In the first embodiment described above, when fuel is injected through the outputting nozzle hole 21 formed in the peripheral region, the central region on the lower surface of the nozzle hole plate 20 is cooled by injecting fuel through the cooling nozzle hole 22 in the central region such that fuel flows in the cooling nozzle hole 22.

Moreover, because fuel injected through the cooling nozzle hole 22 does not need to contribute to the engine output, it does not need to be atomized to spread in the combustion chamber 106. Therefore, a small amount of fuel injected from the cooling nozzle hole 22 is locally atomized near the central region. Because fuel injected through the cooling nozzle hole 22 is atomized near the end face of the central region, direct exposure of the end face to hot gas in the combustion chamber 106 is limited by fuel stagnated and evaporated near the end face.

As a result, at the time of the fuel injection by the injector 10, that is, at the time of the fuel injection through the cooling nozzle hole 22, the central region area on the lower surface of the nozzle hole plate 20 is cooled down by fuel flowing in the cooling nozzle hole 22 as a result of the fuel injection. Furthermore, since fuel injected and atomized through the cooling nozzle hole 22 remains near the central region area, the nozzle hole plate 20 before the combustion is cooled, so that the heat temperature of the nozzle hole plate 20 is reduced. Hence, the increase of the heat temperature of the nozzle hole plate 20 is limited after the combustion.

Additionally, the reason why the fuel to be injected through the cooling nozzle hole 22 has a cooling effect is that the fuel is supplied to the injector 10 from a fuel tank and its temperature is enough lower than the heat temperature of the nozzle hole formation area.

Other embodiments to which the invention is applied are explained below. In the following embodiments, the same numeral as the first embodiment is used for the same configuration as or an equivalent configuration to the first embodiment, and its explanation is not repeated.

### Second Embodiment

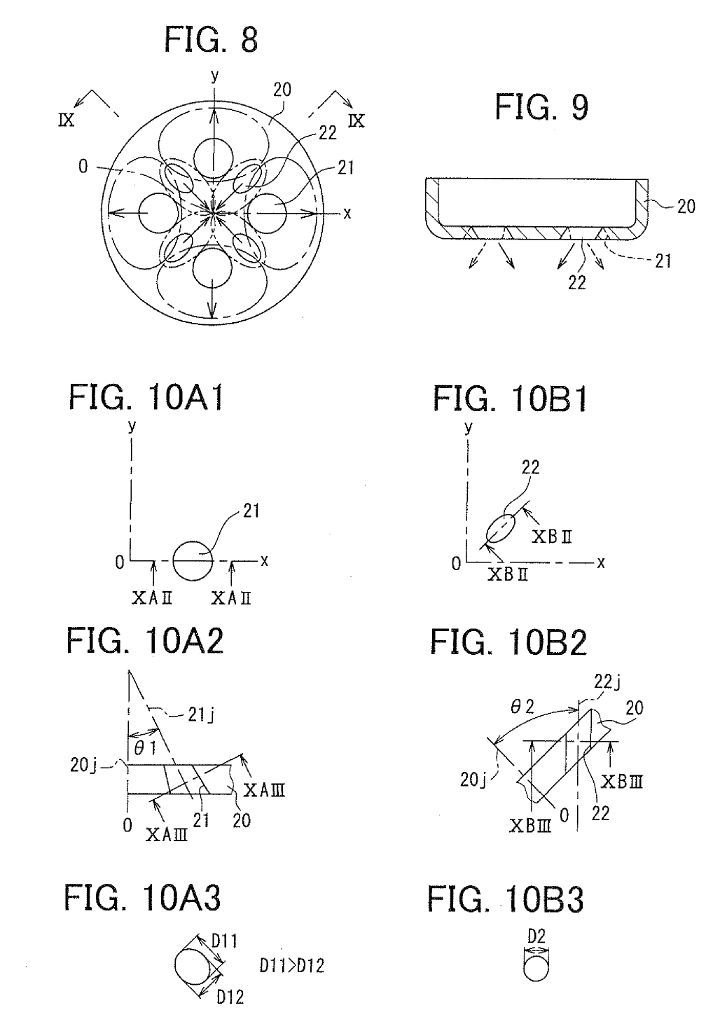

The second embodiment is shown in FIG. 8. The second embodiment illustrates shapes of nozzle holes 21, 22 in order that a fuel spray remains immediately on a lower surface of a nozzle hole plate 20 in an efficient manner.

On a lower surface of a nozzle hole plate 20 shown in FIG. 8, a size (alternate long and two short dashes line in FIG. 8) of a spray of fuel injected through a cooling nozzle hole 22 overlaps with an occupying area, which is occupied by a spray (alternate long and short dash line in FIG. 8) of fuel injected through the outputting nozzle hole 21.

More specifically, the outputting nozzle hole 21 is formed to be a tapered hole (see FIG. 10A2), and its sectional shape is an ellipse (see FIG. 10A3) having a major axis D11 in a circumferential direction of the nozzle hole plate 20, instead of a circle. Accordingly, the size of the spray of fuel injected through the outputting nozzle hole 21 occupies comparatively widely the nozzle hole plate 20 in its circumferential direction.

Thus, the spray of fuel injected from the cooling nozzle hole 22 is easily arranged on only an area, which the fuel spray of the outputting nozzle hole 21 does not occupy. In addition, the cooling nozzle hole 22 has a circular cross section (FIG. 10B3), and is a straight hole (FIG. 10B2).

### Third Embodiment

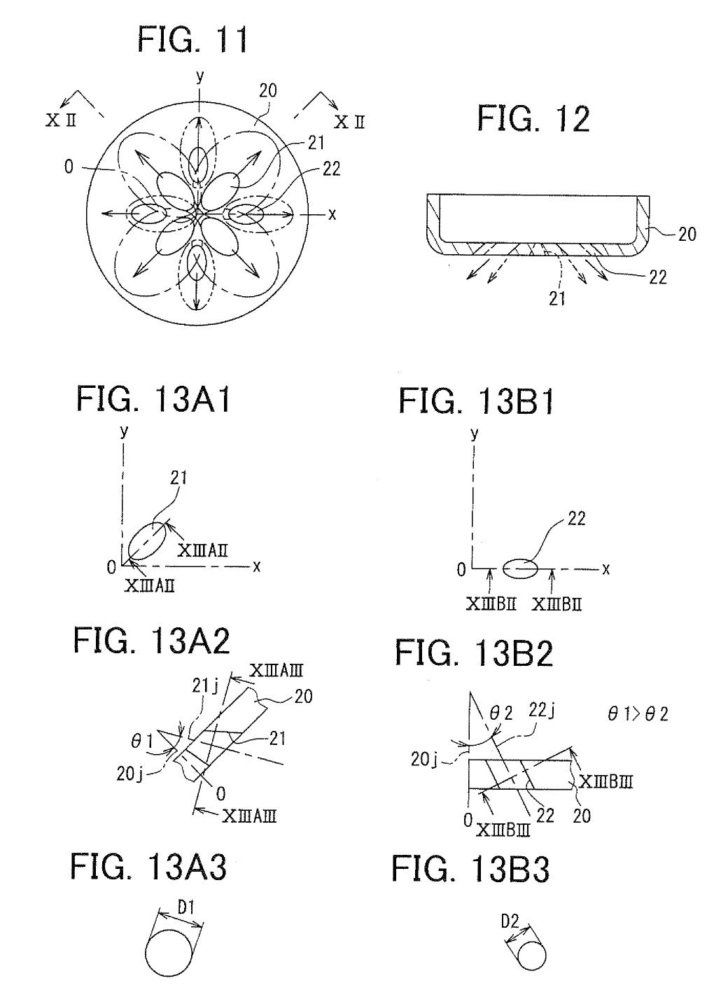

A third embodiment of the invention is shown in FIG. 11. The third embodiment illustrates that a direction of a second hole axis 22j of a cooling nozzle hole 22 and a direction of a first hole axis 21j of an outputting nozzle hole 21 are inclined to be further away from a central axis 20j of a nozzle hole plate 20 in a direction from their respective inlets toward outlets.

As shown in FIG. 12, the outputting nozzle hole 21 and the cooling nozzle hole 22 are formed such that the first hole axis 21j and the second hole axis 22j do not cross.

Since the first hole axis 21j and the second hole axis 22j do not cross in the above manner, it is possible to form a fuel spray through the outputting nozzle hole 21 into a shape that easily spreads in the combustion chamber 106, for example, a spray having a hollow conical shape. Furthermore, the disorder of the fuel spray on a side of the outputting nozzle hole 21 by the fuel spray on a side of the cooling nozzle hole 22 is avoided.

Additionally, the outputting nozzle hole 21 is formed to be a tapered hole (see FIG. 13A2), and has a circular sectional shape (FIG. 13A3). Consequently, the outputting nozzle hole 21 does not need to have an elliptical sectional shape and therefore, the outputting nozzle hole 21 is easy to form.

### Fourth Embodiment

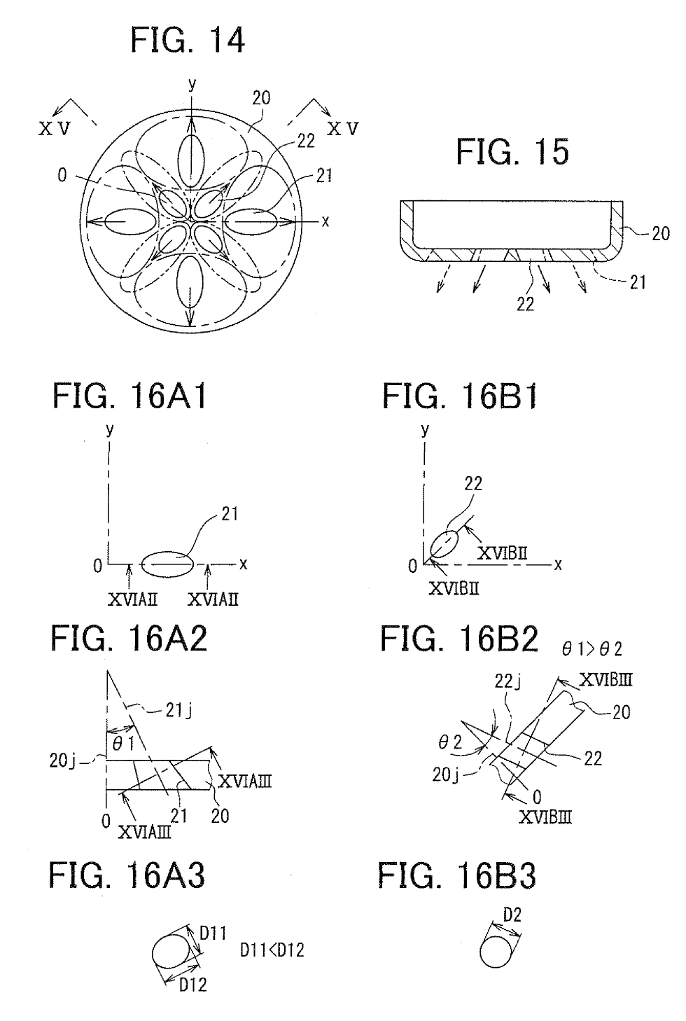

A fourth embodiment of the invention is shown in FIG. 14. The fourth embodiment illustrates that a second hole axis 22j of a cooling nozzle hole 22 and a first hole axis 21j of an outputting nozzle hole 21 are inclined to be further away from a central axis 20j in a direction from their respective inlets toward outlets and that the cooling nozzle hole 22 is formed in a central region, and the outputting nozzle hole 21 is formed in a peripheral region.

As shown in FIG. 15, the outputting nozzle hole 21 and the cooling nozzle hole 22 may be formed such that the first hole axis 21j and the second hole axis 22j do not cross.

Accordingly, even when the outputting nozzle hole 21 is arranged in the peripheral region and the cooling nozzle hole 22 is arranged in the central region, since the first hole axis 21j and the second hole axis 22j do not cross, it is possible to form a fuel spray through the outputting nozzle hole 21 into a shape that easily spreads in the combustion chamber 106, for example, a spray having a hollow conical shape. Furthermore, the disorder of the fuel spray on a side of the outputting nozzle hole 21 by the fuel spray on a side of the cooling nozzle hole 22 is avoided.

In addition, as shown in FIG. 16A3 and FIG. 16B3, an opening area A2 of the cooling nozzle hole 22 may be smaller than an opening area A1 of the outputting nozzle hole 21.

Accordingly, a penetration of the cooling nozzle hole 22 is shorter than a penetration of the outputting nozzle hole 21, and thus the fuel spray on the side of the cooling nozzle hole 22 is easily kept near the central region. Moreover, because the penetration of the cooling nozzle hole 22 is shorter than the penetration of the outputting nozzle hole 21, the fuel spray of the cooling nozzle hole 22 does not spread in the combustion chamber 106 like the fuel spray on the side of the outputting nozzle hole 21. Therefore, the combustion of the fuel spray on the side of the cooling nozzle hole 22 prior to the combustion of the fuel spray on the side of the outputting nozzle hole 21 is avoided.

By delaying the combustion of the fuel spray on the side of the cooling nozzle hole 22 as far as possible in the above manner, the fuel spray on the side of the cooling nozzle hole 22 remains near the central region.

In the fourth embodiment described above, when fuel is injected through the outputting nozzle hole 21 formed in the peripheral region, the central region on the lower surface of the nozzle hole plate 20 is cooled by injecting fuel through the cooling nozzle hole 22 in the central region such that fuel flows in the cooling nozzle hole 22. Furthermore, since the fuel injected from the cooling nozzle hole 22 does not need to contribute to the engine output, a small amount of fuel injected from the cooling nozzle hole 22 is locally atomized near an end face part of the central region.

At the time of the fuel injection of the injector 10, the central region on the lower surface of the nozzle hole plate 20 is cooled by fuel flowing in the cooling nozzle hole 22, and the fuel injected and atomized from the cooling nozzle hole 22 remains near the central region. As a result, the nozzle hole plate 20 before the combustion is cooled down and thereby the heat temperature of the nozzle hole plate 20 is reduced. Hence, the increase of the heat temperature of the nozzle hole plate 20 is limited after the combustion.

Additional advantages and modifications will readily occur to those skilled in the art. The invention in its broader terms is therefore not limited to the specific details, representative apparatus, and illustrative examples shown and described.

What is claimed is:

1. An injector that is configured to inject fuel into a cylinder of an internal combustion engine, the injector comprising a nozzle hole formation part that includes:
a nozzle hole formation area that is an end surface of the nozzle hole formation part on a downstream side of the nozzle hole formation part in a fuel flow direction; and
a plurality of nozzle holes which is formed in a shape of at least one circle in the nozzle hole formation area and through which fuel is injected, wherein:
the nozzle hole formation area is divided into a central region and a peripheral region by a predetermined circle that is concentric with the at least one circle, the central region being located radially inward from the predetermined circle and the peripheral region being located on an outer circumferential side of the central region;
the plurality of nozzle holes includes a plurality of outputting nozzle holes formed in the peripheral region such that fuel is injected into the cylinder through the plurality of outputting nozzle holes to contribute to an output of the engine, and at least one cooling nozzle hole in the central region such that a smaller amount of fuel than an amount of fuel flowing through the outputting nozzle hole is injected through the at least one cooling nozzle hole so as to cool the central region; and
the plurality of outputting nozzle holes and the at least one cooling nozzle hole are configured such that a ratio of a second total amount of fuel flowing through the at least one cooling nozzle hole to an overall total fuel amount that is a sum of the second total amount and a first total amount of fuel flowing through the plurality of outputting nozzle holes is in a range of 0.05 to 0.37.

2. The injector according to claim 1, wherein the at least one cooling nozzle hole includes at least two cooling nozzle holes.

3. The injector according to claim 1, wherein the plurality of outputting nozzle holes and the at least one cooling nozzle hole are formed such that an opening area of each of the at least one cooling nozzle hole is smaller than an opening area of each of the plurality of outputting nozzle holes.

4. The injector according to claim 3, wherein the plurality of outputting nozzle holes and the at least one cooling nozzle hole are formed to satisfy an expression of 1/10×A1≦A2≦½×A1 given that A1 is the opening area of each of the plurality of outputting nozzle holes and A2 is the opening area of each of the at least one cooling nozzle hole.

5. The injector according to claim 1, further comprising:
a valve body having an annular valve seat on an inner circumferential surface of the valve body, which defines a part of a fuel flow passage; and
a valve member accommodated in the valve body and configured to one of engage and disengage from the valve seat, wherein the nozzle hole formation part is a nozzle hole plate, which is disposed on a downstream side of the valve seat in the fuel flow direction and includes the plurality of nozzle holes such that fuel supplied through the fuel flow passage is injected through the plurality of nozzle holes when the valve member disengages from the valve seat.

6. The injector according to claim 5, wherein:
the plurality of outputting nozzle holes is formed such that a first hole axis of each of the plurality of outputting nozzle holes separates from a central axis of the nozzle hole plate extending in a thickness direction of the nozzle hole plate in a direction from an fuel inlet side toward an fuel outlet side of the nozzle hole plate; and
the at least one cooling nozzle hole is formed such that a second hole axis of each of the at least one cooling nozzle hole approaches the central axis of the nozzle hole plate in the direction from the fuel inlet side toward the fuel outlet side of the nozzle hole plate.

7. The injector according to claim 5, wherein:
the plurality of outputting nozzle holes is formed such that a first hole axis of each of the plurality of outputting nozzle holes separates from a central axis of the nozzle hole plate extending in a thickness direction of the nozzle hole plate in a direction from an fuel inlet side toward an fuel outlet side of the nozzle hole plate;
the at least one cooling nozzle hole is formed such that a second hole axis of each of the at least one cooling nozzle hole separates from the central axis of the nozzle hole plate in the direction from the fuel inlet side toward the fuel outlet side of the nozzle hole plate; and
the first hole axis and the second hole axis do not cross.

8. The injector according to claim 7, wherein the at least one cooling nozzle hole is formed such that a certain area of the nozzle hole formation area is cooled by fuel flowing through the at least one cooling nozzle hole and that fuel injected through the at least one cooling nozzle hole contributes to a part of the output of the engine.

9. An injector that is configured to inject fuel into a cylinder of an internal combustion engine, the injector comprising a nozzle hole formation part that includes:
a nozzle hole formation area that is an end surface of the nozzle hole formation part on a downstream side of the nozzle hole formation part in a fuel flow direction; and
a plurality of nozzle holes which is formed in a shape of at least one circle in the nozzle hole formation area and through which fuel is injected, wherein:
the nozzle hole formation area is divided into a central region and a peripheral region by a predetermined circle that is concentric with the at least one circle, the peripheral region being located radially outward from the predetermined circle and the central region being located on an inner circumferential side of the peripheral region;
the plurality of nozzle holes includes a plurality of outputting nozzle holes formed in the central region such that fuel is injected into the cylinder through the plurality of outputting nozzle holes to contribute to an output of the engine, and at least one cooling nozzle hole in the peripheral region such that a smaller amount of fuel than an amount of fuel flowing through the outputting nozzle hole is injected through the at least one cooling nozzle hole so as to cool the peripheral region; and
the plurality of outputting nozzle holes and the at least one cooling nozzle hole are configured such that a ratio of a second total amount of fuel flowing through the at least one cooling nozzle hole to an overall total fuel amount that is a sum of the second total amount and a first total amount of fuel flowing through the plurality of outputting nozzle holes is in a range of 0.05 to 0.37.

10. The injector according to claim 9, wherein the plurality of outputting nozzle holes and the at least one cooling nozzle hole are formed such that an opening area of each of the at least one cooling nozzle hole is smaller than an opening area of each of the plurality of outputting nozzle holes.

11. The injector according to claim 10, wherein the plurality of outputting nozzle holes and the at least one cooling nozzle hole are formed to satisfy an expression of 1/10×A1≦A2≦½×A1 given that A1 is the opening area of each of the plurality of outputting nozzle holes and A2 is the opening area of each of the at least one cooling nozzle hole.

12. The injector according to claim 9, further comprising:
a valve body having an annular valve seat on an inner circumferential surface of the valve body, which defines a part of a fuel flow passage; and
a valve member accommodated in the valve body and configured to one of engage and disengage from the valve seat, wherein the nozzle hole formation part is a nozzle hole plate, which is disposed on a downstream side of the valve seat in the fuel flow direction and includes the plurality of nozzle holes such that fuel supplied through the fuel flow passage is injected through the plurality of nozzle holes when the valve member disengages from the valve seat.

13. The injector according to claim 12, wherein:
the plurality of outputting nozzle holes is formed such that a first hole axis of each of the plurality of outputting nozzle holes separates from a central axis of the nozzle hole plate extending in a thickness direction of the nozzle hole plate in a direction from an fuel inlet side toward an fuel outlet side of the nozzle hole plate;
the at least one cooling nozzle hole is formed such that a second hole axis of each of the at least one cooling nozzle hole separates from the central axis of the nozzle hole plate in the direction from the fuel inlet side toward the fuel outlet side of the nozzle hole plate; and
the first hole axis and the second hole axis do not cross.

14. The injector according to claim 13, wherein the at least one cooling nozzle hole is formed such that a certain area of the nozzle hole formation area is cooled by fuel flowing through the at least one cooling nozzle hole and that fuel injected through the at least one cooling nozzle hole contributes to a part of the output of the engine.

15. An injector that is configured to inject fuel into a cylinder of an internal combustion engine, the injector comprising a nozzle hole formation part that includes:
a nozzle hole formation area that is an end surface of the nozzle hole formation part on a downstream side of the nozzle hole formation part in a fuel flow direction; and
a plurality of nozzle holes which is formed in a shape of at least one circle in the nozzle hole formation area and through which fuel is injected, wherein:
the nozzle hole formation area is divided into a central region and a peripheral region by a predetermined circle that is concentric with the at least one circle, the central region being located radially inward from the predetermined circle and the peripheral region being located on an outer circumferential side of the central region;
the plurality of nozzle holes includes a plurality of outputting nozzle holes formed in the peripheral region and at least one cooling nozzle hole formed in the central region;
the plurality of outputting nozzle holes and the at least one cooling nozzle hole are formed such that a spray travel of fuel injected through each of the at least one cooling nozzle hole is shorter than a spray travel of fuel injected through each of the plurality of outputting nozzle holes when the injector injects fuel;
the plurality of outputting nozzle holes and the at least one cooling nozzle hole are formed to satisfy an expression of 1/10×A1≦A2≦½×A1 given that A1 is an opening area of each of the plurality of outputting nozzle holes and A2 is an opening area of each of the at least one cooling nozzle hole;
the plurality of outputting nozzle holes is formed such that a first hole axis of each of the plurality of outputting nozzle holes separates from a central axis of the nozzle hole formation part extending in a thickness direction of the nozzle hole formation part in a direction from an fuel inlet side toward an fuel outlet side of the nozzle hole formation part; and
the at least one cooling nozzle hole is formed such that a second hole axis of each of the at least one cooling nozzle hole approaches the central axis of the nozzle hole formation part in the direction from the fuel inlet side toward the fuel outlet side of the nozzle hole formation part.

16. The injector according to claim 15, wherein the plurality of outputting nozzle holes and the at least one cooling nozzle hole are configured such that a ratio of a second total amount of fuel flowing through the at least one cooling nozzle hole to an overall total fuel amount that is a sum of the second total amount and a first total amount of fuel flowing through the plurality of outputting nozzle holes is in a range of 0.05 to 0.37.

17. The injector according to claim 15, wherein:
a first inclined angle between the first hole axis and the central axis is set in a range of 5 to 60°; and
a second inclined angle between the second hole axis and the central axis is set in a range of 30 to 80°.

18. The injector according to claim 17, wherein the first inclined angle is set in a range of 25 to 60°.
